(19) United States
(12) Patent Application Publication
(10) Pub. No.: US 2008/0070215 A1
(43) Pub. Date: Mar. 20, 2008

(54) Educational and entertainment apparatus for the playback of recorded audio and video media to a young child

(76) Inventor: Deborah C. Hunter, Bakersfield, CA (US)

Correspondence Address: Galasso & Associates, LP, P.O. Box 26503, Austin, TX, 78755-0503, US

(21) Appl. No.: 11/504,185

(22) Filed: Aug. 15, 2006

(51) Int. Cl. G09B 5/00

(52) U.S. Cl. 434/317

(57) ABSTRACT

An educational and entertainment device for the playback of recorded audio and video media to a young child reclining in a stroller or crib is disclosed. The educational and entertainment device comprises a digital media player such as a digital video disc and/or audio disc player device which is secured to and preferably built into the crib or stroller so as to be delivered to the consumer as a unit. The video disc player device comprises a playback unit adapted to receive and visually/auditorily reproduce a recorded DVD or CD. One or more audio speakers are driven by the playback unit and is secured nearby to the reclined or seating location of the young child. A viewing screen assembly is secured to the crib or stroller and oriented such as to be viewable by the young child such that the young child is provided with an array of educational and entertaining recorded media.

### FIELD OF THE DISCLOSURE

The disclosures made herein relate generally to electronic educational and entertainment media playback devices and child strollers, carriages, and cribs and more particularly electronic educational and entertainment media playback devices adapted for and built into crib beds, strollers and other protective infant recline or seating apparatuses.

### BACKGROUND

The use of media playback devices is know in the prior art. Playback devices are known for various types of recorded media from tapes, to vinyl records, to video tapes, audio compact discs (CDs), digital video discs (DVDs), flash memory cards, directly from hard disc media and streaming content over the internet, among others. Playback device are in various sizes and forms from past age relatively stationary devices that serve also as furniture in a room such as console stereos, to compact light weight battery operated media playback devices such as portable CD players, DVD players and portable music and media players. Many of these types of devices have been adapted through the years to educational as well as entertainment purposes by the availability of recorded educational media of various types. The field of such devices is crowded with the above types of devices that have been developed to fulfill countless objectives and requirements.

In the prior art however, the need still exists today for an entertainment and educational media playback device that is adapted and configured to be provided as part of an improved child crib bed and stroller to educate and entertain an infant reclining or seated therein. Parents are continually confronted with the reality that infant children have notoriously short attention spans and therefore become bored, disinterested and then unhappy and restless rather quickly. Young children are ever curious and inquisitive about the world which surrounds them. Left to their own devices, infants and children will do their best to bravely explore and test their environment to the limits of their developing physical prowess, seemingly unaware of dangers. In contrast, when children are constrained within protective and retentive devices such as infant strollers or infant cribs, the lack of sensory stimulation and intellectual experiences can cause children to become restless, dissatisfied and whiney, making these children a burden to their parents and to unfortunate nearby members of society.

What is needed in such cases is a source of sensory and intellectual stimulation to occupy and satisfy the ever present curiosity of the infant while they are in the stroller or resting in the crib. No source of sensory stimulation works for an extended time, due to the short attention span of the infant or young child, but an interesting and varied source of entertainment and even more ideally educational material, will satisfy the curiosity and sensory needs of the infant for a while, thereby providing the parents as well as the infant with some quiet peaceful downtime.

Therefore, an educational and entertainment device for the playback of recorded audio and video media to an infant or young child, a device which is adapted and configured to be built into or onto improved varieties of infant cribs and infant strollers, a media playback device that is capable of playback of audio as well as video media to an infant or young child, a device which is secured to and built onto or into the crib or stroller is not easily damaged or dropped by the infant, a media playback device that entertains and educates the infant, a media playback device that provides peaceful downtime for the parent or guardian, a media playback device that can be used to hasten and develop the learning and curiosity of very young children, such an educational and entertainment device for the playback of recorded audio and video media to an infant would be useful and novel.

### SUMMARY OF THE DISCLOSURE

In a first embodiment of the inventive disclosures made herein, an educational and entertainment device for the playback of recorded audio and video media to an infant comprises a protective apparatus for supporting and containing an infant therein, and a digital media player device secured onto the protective apparatus. The video disc player device comprises a playback unit adapted to receive, decode, and visually and auditorily reproduce a recorded audio or audio/visual media, one or more audio speakers electrically connected to and driven by the playback unit and secured or placed nearby to the reclined or seating location of the infant, a viewing screen assembly having on one side a video display screen surface for the display of playback and decoded video media contents. The viewing screen assembly is electrically connected to the playback unit. The display screen surface is oriented such as to be viewable by the infant.

In a second embodiment of the inventive disclosures made herein, an educational and entertainment device for the playback of recorded audio and video media to an infant comprises the first embodiment wherein the media player device is a digital video disc playback device.

In a third embodiment of the inventive disclosures made herein, an educational and entertainment device for the playback of recorded audio and video media to an infant comprises the first embodiment wherein the media player device is a digital video disc playback device further adapted to play audio CDs.

In a fourth embodiment of the inventive disclosures made herein, an educational and entertainment device for the playback of recorded audio and video media to an infant comprises the third embodiment wherein the protective apparatus for supporting and containing an infant is a infant stroller having a wheeled carriage, a cushion platform for receiving and supporting the infant, baby or young child. A lap tray is secured to a front portion of the carriage. The lap tray positioned to be in the forward field of view of the child in the stroller. The digital video disc playback device is supported by the lap tray and accessible at a top surface of the tray such that recorded media may be inserted and played in the media playback unit. The viewing screen assembly is hingeably connected to the playback unit such that the viewing screen is pivotal between a closed position facing the tray and an open position in which the screen is viewable by the infant.

In a fifth embodiment of the inventive disclosures made herein, an educational and entertainment device for the playback of recorded audio and video media to an infant comprises the fourth embodiment wherein the digital video disc playback device is removably secured to the tray.

In a sixth embodiment of the inventive disclosures made herein, an educational and entertainment device for the playback of recorded audio and video media to an infant comprises the fourth embodiment wherein the digital video disc playback device is secured to and built into the lap tray of the stroller and wherein the viewing screen is closable into the top surface of the lap tray such as to form a smooth tray top surface for use by the infant when closed.

In a seventh embodiment of the inventive disclosures made herein, an educational and entertainment device for the playback of recorded audio and video media to an infant comprises the third embodiment wherein the protective apparatus for supporting and containing an infant in a crib bed for an infant having a cushion platform for receiving and supporting the infant and four substantially vertical retentive members. The substantially vertical retentive members comprise two opposing side members, a headboard member secured at opposing edges secured to a first edge of each side member and a footboard member secured at opposing edges secured to a second edge of each side member. A frame supports the cushion platform and the frame secured to two or more of the vertical retentive members such as to form a conventional crib type bed for an infant. The digital video disc playback device is secured to and built into the footboard member of the crib and is accessible through an outside surface of the footboard member such that recorded media may be inserted into the playback unit and played from a position outside of the crib. The viewing screen assembly is secured to an inside surface of the footboard member so that the viewing screen is in a facing and viewable relationship with the infant and therefore easily viewed and observed by the infant resting, laying or sitting within the crib.

With the educational and entertainment device for the playback of recorded audio and video media to an infant or young child of the present inventive disclosure, parents have the ability to play DVDs or CDs to entertain their young children or infants in the stroller while shopping at the mall, relaxing at the park or beach, or just taking a leisurely walk through the neighborhood.

The educational and entertainment device for the playback of recorded audio and video media to an infant or young child of the present inventive disclosure is additionally an effective tool in the pre-school education of young children as it allows parents to stimulate the minds of their young children by offering them a wide array of educational material at any time and in any place.

All parents desire the best for their children and this includes giving them the best possible start on their education. The present invention can help parents achieve this goal by providing an environment that is safe and stimulating. The present invention can be utilized while parents are getting ready for work, doing housework, making beds, doing the dishes, or performing a variety of necessary tasks. Instead of allowing the child to sit idly and passively by during these times, the present invention offers the option to stimulate the curiosity of, educate and entertain the child with an assortment of educational or entertainment material.

It is an objective of the inventive disclosure made herein to provide an educational and entertainment device for the playback of recorded audio and video media to an infant or young child which is adapted and configured to be built into or onto improved varieties of crib beds and strollers.

It is another objective of the inventive disclosure made herein to provide a media playback device that is capable of playback of audio as well as video media to the young child.

It is another objective of the inventive disclosure made herein to provide a media playback device which is secured to and built onto or into the crib or stroller and is not easily damaged or dropped by the infant or young child.

It is another objective of the inventive disclosure made herein to provide a media playback device that entertains and educates the infant or young child.

It is another objective of the inventive disclosure made herein to provide a media playback device that provides peaceful downtime for the parent or guardian.

It is another objective of the inventive disclosure made herein to provide a media playback device that can be used to hasten and develop the learning and curiosity of very young children.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of an infant or young child crib bed having built into the foot board wall an educational and entertainment device for the playback of recorded audio and video media in accordance with one embodiment of the inventive disclosures made herein.

FIG. 2 depicts a perspective view of an educational and entertainment device for the playback of recorded audio and video media in accordance with one embodiment of the inventive disclosures made herein, the embodiment illustrated being intended for mounting into the foot board wall of a crib.

FIG. 3 depicts a view from within the crib bed of the footboard of the crib bed having built in thereto an educational and entertainment device for the playback of recorded audio and video media in accordance with one embodiment of the inventive disclosures made herein.

FIG. 4 depicts a top view of a stroller or carriage for a young child having built in to the lap table an educational and entertainment device for the playback of recorded audio and video media in accordance with one embodiment of the inventive disclosures made herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

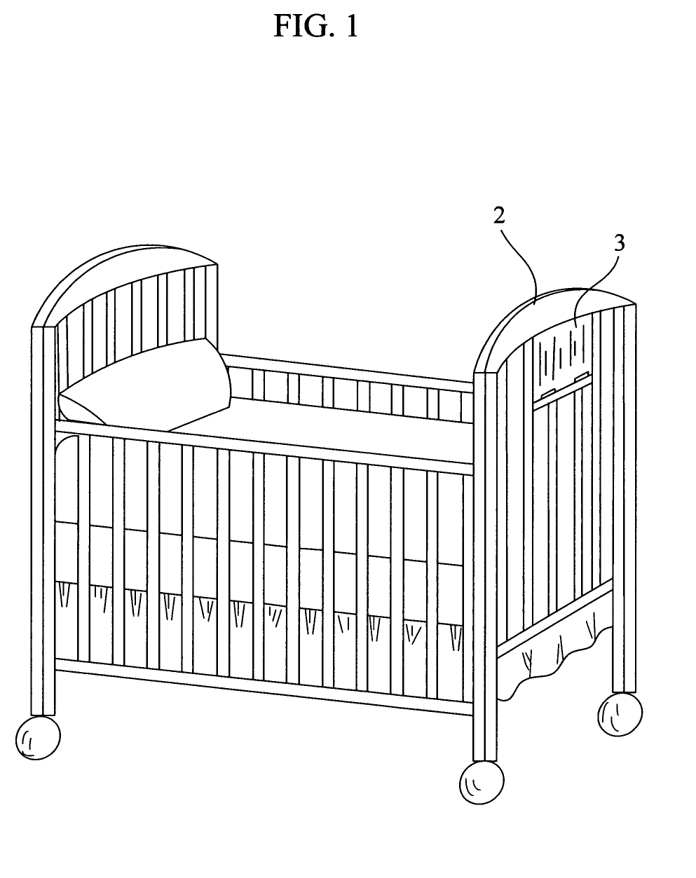

Focusing now on FIG. 1, 2 and 3:

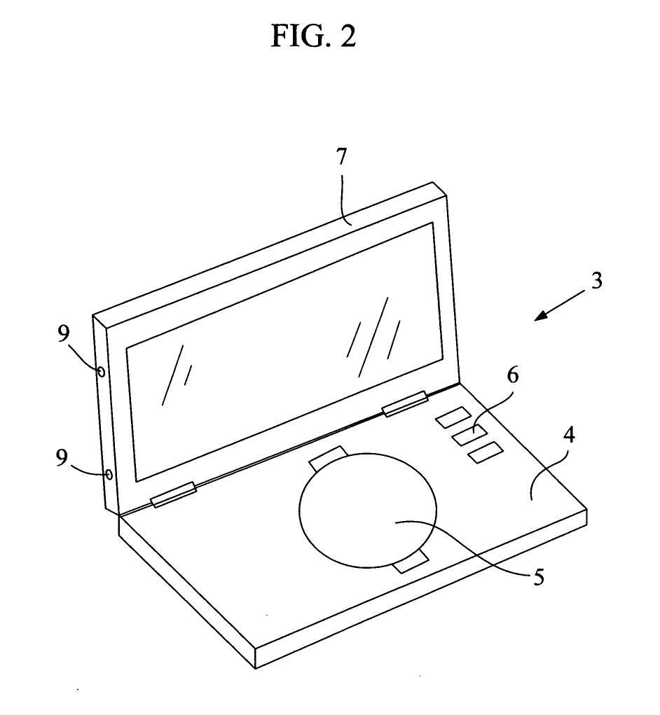

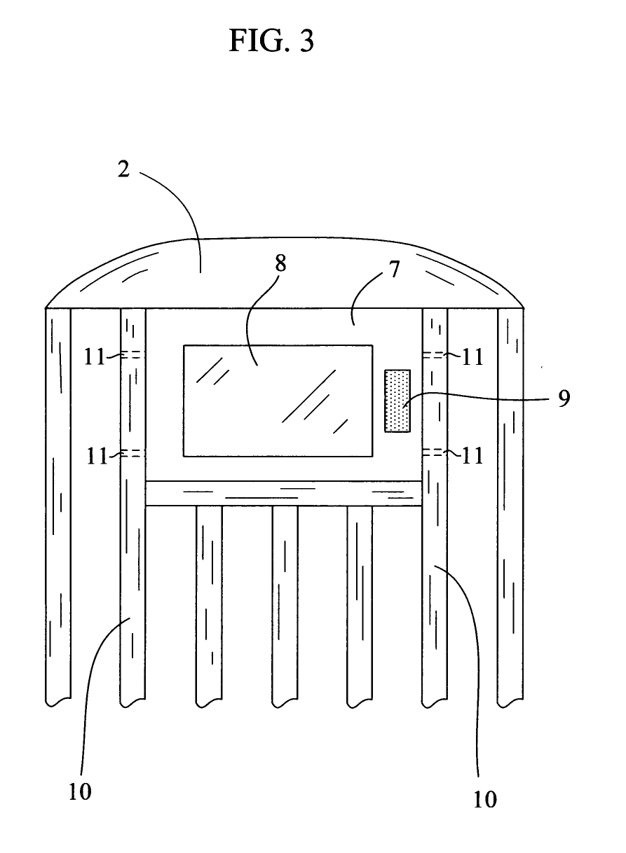

FIG. 1 depicts a perspective view of a crib bed having built into the foot board wall an educational and entertainment device for the playback of recorded audio and video media in accordance with one embodiment of the inventive disclosures made herein. FIG. 2 depicts a perspective view of an educational and entertainment device for the playback of recorded audio and video media in accordance with one embodiment of the inventive disclosures made herein, the embodiment illustrated being intended for mounting into the foot board wall of a crib. FIG. 3 depicts a view from within the crib bed of the footboard of the crib having built in thereto an educational and entertainment device for the playback of recorded audio and video media in accordance with one embodiment of the inventive disclosures made herein.

A child's crib bed 1 has a footboard wall 2 into which an entertainment and education device for the playback of recorded media 3 is secured. The media playback device 3 comprises a media playback unit 4 having the mechanism and electronics for reading and decoding digitally recorded media from a CD or DVD. The DVD player has an access door 5 which is opened to insert or remove digital media from the playback unit 3. The playback unit 3 has one or more finger operable control means 6 to control the playback of media. The DVD player 5 is hingeably and supportively connected along the bottom edge to the viewing screen assembly 7. The viewing screen assembly 7 has an electronic illuminated color display screen 8, which as shown in FIG. 3 is oriented to face the interior of the crib where the infant or child can view the screen. In the illustrated embodiment an audio speaker is located behind the speaker grill holes 9 located on the viewing screen assembly 7, and oriented towards the interior of the crib, although the illustrated location of the speaker is not limiting as the speaker or speakers can be located anywhere within or near the crib without deviating from the intent of this disclosure. In the illustrated embodimnent the viewing screen assembly 7 includes a plurality of threaded holes on opposing sides of the viewing screen assembly. The media playback device is secured to the crib footboard by a plurality of screws inserted through holes 11 in the rails 10 and threadably received into the threaded holes of the playback device although other means of securing the media playback device to the crib wall can be used without deviating from the intent of this inventive disclosure.

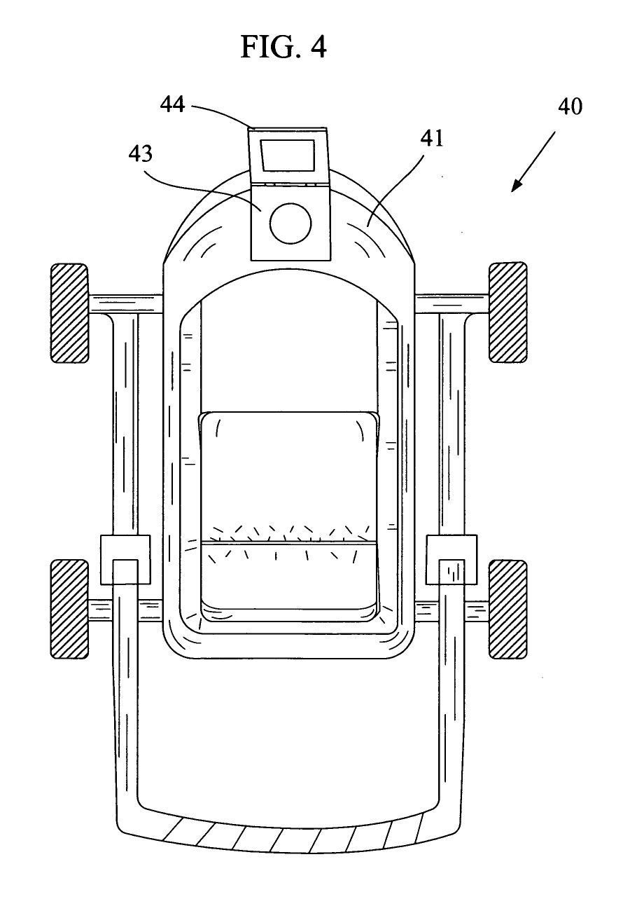

Turning now to FIG. 4:

FIG.4 depicts a top view of a stroller 40 or carriage for a young child having built in to the lap table an educational and entertainment device for the playback of recorded audio and video media in accordance with one embodiment of the inventive disclosures made herein. A baby stroller 40 incorporates features of the inventive disclosures presented herein. The stroller 40 has a lap tray table 41 secured to the frame of the stroller. The lap tray table has a media playback device 42 secured to and built into the lap table. The media playback device comprises a digital media player 43 which is secured to a recess in the lap table 41. An electronic viewing screen assembly 44 is hingeably connected to the digital media player 43. The digital media player 43 is recessed into the lap tables such that when the viewing screen assembly 44 is pivoted to a closed position on the digital media player 43, that the exposed top surface of the closed viewing screen is substantially coplanar to the top surface of the lap table 41 such that the lap table functions for the child as one continuous lap table surface into which the media playback device is hidden. The media playback unit 43 has the mechanism and electronics for reading and decoding digitally recorded media from a CD or DVD.

The discussed construction, illustrations and sequence of operation is for one embodiment of the invention but is in no way limiting to other embodiments. The operating modes may be changed and enhanced without deviating from the intention of this inventive disclosure.

In the preceding detailed description, reference has been made to the accompanying drawings that form a part hereof and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, electrical, electronic and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents as can be reasonably included within the spirit and scope of the appended claims.

What is claimed is:

1. An educational and entertainment apparatus for the playback of recorded audio and video media to a young child, comprising:
a protective apparatus for supporting and containing a young child therein; and
a recorded media player device secured to the protective apparatus, the media player device comprising:
a playback unit;
one or more audio speakers electrically connected to and driven by the playback unit; and
a viewing screen assembly having on one side a video display screen surface, the viewing screen assembly electrically connected to the playback unit, the display screen surface positioned to be viewable by the child, wherein the playback unit is adapted to play video and audio media.

2. The educational and entertainment apparatus of claim 1, wherein the media player device is a digital video disc playback device.

3. The educational and entertainment apparatus of claim 2, wherein the media player device is a digital video disc playback device further adapted to play audio CDs.

4. The educational and entertainment apparatus of claim 3, wherein:
the protective apparatus for supporting and containing an infant is a young child stroller comprising:
a wheeled carriage;
a cushion platform for receiving and supporting said child, the cushion platform secured to the wheeled carriage; and
a lap tray secured to a front portion of the carriage, the tray positioned to be in the forward field of view of the child in stroller;
wherein said digital video disc playback device is supported by said tray and accessible at a top surface of said tray such that recorded media may be inserted and played; and
wherein the viewing screen assembly is hingeably connected to said playback unit such that the viewing screen is pivotal between a closed position facing the tray and an open position in which the screen is viewable by the infant.

5. The educational and entertainment apparatus of claim 4, wherein said digital video disc playback device is removably secured to the tray.

6. The educational and entertainment apparatus of claim 4, wherein said digital video disc playback device is secured to and built into the tray and wherein the viewing screen is closable into a top surface of the tray such as to form a smooth tray top surface when closed.

7. The educational and entertainment apparatus of claim 3, wherein:
the protective apparatus for supporting and containing a young child is a crib bed, comprising:
a cushion platform for receiving and supporting said child;
four substantially vertical retentive members comprising:
two opposing side members;
a headboard member secured at opposing edges secured to a first edge of each side member; and
a footboard member secured at opposing edges secured to a second edge of each side member;
a frame supporting said cushion platform, the flame secured to two or more of the vertical retentive members,
wherein said digital video disc playback device is secured to and built into the footboard member and accessible through an outside surface of said footboard member such that recorded media may be inserted and played from outside the crib; and
wherein the viewing screen assembly is secured to a an inside surface of the footboard member wherein the viewing screen is in a facing and viewable relationship with the child.
